(19) United States
(12) Patent Application Publication
(10) Pub. No.: US 2015/0125743 A1
(43) Pub. Date: May 7, 2015

(54) BATTERY ELECTRODE MATERIALS

(71) Applicant: NANO-NOUVELLE PTY LTD, Marcoola, Queensland (AU)

(72) Inventors: Geoffrey Alan Edwards, Point Arkwright (AU); Peter Anthony George, Marcoola (AU); Quansheng Song, Maroochydore (AU)

(73) Assignee: NANO-NOUVELLE PTY LTD, Marcoola, Queensland (AU)

(21) Appl. No.: 14/398,684

(22) PCT Filed: May 2, 2013
(86) PCT No.: PCT/AU2013/000458

§ 371 Date: Nov. 3, 2014

(30) Foreign Application Priority Data
May 4, 2012 (AU) 2012901831
Jun. 14, 2012 (AU) 2012902495
Dec. 21, 2012 (AU) 2012905645
Mar. 28, 2013 (AU) 2013901090

(51) Int. Cl. H01M 4/02; H01M 4/38

(52) U.S. Cl. CPC H01M 4/02; H01M 4/38; H01M 2004/021
USPC 429/209

(57) ABSTRACT

An electrode material for a battery or for a capacitor, supercapacitor or a pseudo capacitor comprises a porous substrate coated with a coating comprising a conducting material and an active material, wherein the thickness of the coating is less than 1 micrometre and the volume fraction of active material is greater than 5%. In another aspect, the electrode material comprises a metallic network structure and an active material connected to the metallic structure, wherein the calculated volume fraction of active material is greater than 5%, and the surface area of the material is greater than 5 m²/g.

### FIELD OF THE INVENTION

The present invention relates to novel battery electrode materials and batteries using same. In one aspect the invention relates to nickel-based electrode materials and batteries using same.

### BACKGROUND TO THE INVENTION

Considerable demand exists for technology that can significantly improve battery performance. There are several aspects of battery performance that may be important for a given application. For example, the rate at which the battery may be charged determines how long it takes to fully charge the battery. The rate at which the battery may be discharged is critical to how much power the battery can deliver. The amount of energy stored in the battery per unit weight, or the amount of energy stored in the battery per unit volume, may also be important. Power may also be expressed per unit weight or per unit volume. These properties may also be expressed per unit area. Capacity is often used to indicate the amount of charge stored and available for discharge. It is commonly expressed per volume, eg. mAh/cc, or per mass, eg. mAh/g.

The life of a battery is a very important parameter. Battery life is determined by measuring the capacity of the battery that is maintained after a certain number of charge and discharge cycles.

Obtaining sufficient cycle life is key to battery use in many applications. For many batteries, it is necessary to significantly limit the amount that the battery is charged and discharged, relative to its full capacity, or its rated capacity, in order to obtain sufficient cycle life. Rated capacity is the capacity at which the battery is recommended to be used at. The term ‘depth of discharge’ (DOD) can be used to describe this. To achieve sufficient lifetime, it may be necessary to limit a batteries capacity to 10% or 20% of its full capacity. Thus the battery needs' to be ten times or five times larger, respectively, than would otherwise be possible based on its full capacity.

Rate performance, i.e. the ability to charge rapidly, and the ability to discharge rapidly to generate power, is highly desirable in many applications. However high rate charging and/or discharging is generally very detrimental to stability. Again. DOD may need to be severely limited to provide sufficient cycling stability at high rates, effectively limiting capacity. Alternatively, long lifetimes are simply not possible at a given capacity and charge and/or discharge rate.

Clearly there is a pressing need for new battery technology that can simultaneously provide for capacity, high charge and/or discharge rates, and good cycling stability.

Several important battery types, including nickel/metal hydride, nickel/cadmium, nickel/hydrogen, nickel iron and nickel/zinc utilise nickel-based cathode materials. Nickel-based materials also have potential as electrodes in lithium ion batteries. Some capacitors, including super capacitors and pseudo-capacitors, including nickel-carbon capacitors also utilise, nickel-based cathode materials.

It is an object of the present invention to provide novel battery electrode materials that can provide superior combinations of energy capacity, charge rates, discharge rates and cycling stability. It is also an object of the present invention to provide new methods for activating such materials.

### DESCRIPTION OF THE INVENTION

The inventors have discovered electrode materials that can deliver surprising combinations of capacity, high rates of charging and/or discharging, high depths of discharge, high power and high cycling stability.

In one aspect, the present invention provides an electrode material comprising a porous substrate coated with a coating comprising a conducting material and an active material, wherein the thickness of the coating is less than 1 micrometre and the volume fraction of active material is greater than 5%.

Throughout this specification, the term “an active material” will be used to refer to a material that may transform between charged and discharged states. The more charge/discharge transformations (or cycles) that a material can withstand, the greater the stability of the material.

The electrode material of the present invention may be used in a battery or in a capacitor, supercapacitor or a pseudo capacitor, or in an electrochromic device, or indeed in any application where use of a material that can be charged and discharged is required.

The electrode material may have a volume fraction of active material that is greater than 10%, or greater than 20%, or greater than 30%, or greater than 35%, or greater than 50%, or greater than 60%.

In some embodiments, the electrode material may comprise a porous material that is coated with the conductive material and active material. Prior to coating the porous material may have a specific surface area of greater than 0.1 m²/cm³, more preferably greater than 0.2 m²/cm³, more preferably greater than 1 m²/cm³, even more preferably greater than 4 m²/cm³, further preferably greater than 10 m²/cm³, even further preferably greater than 50 m²/cm³. The optimal surface area may vary depending on the exact application.

In some embodiments, the electrode material may have a calculated ratio of volume of active material to volume of metallic material is greater than 1.5, or greater than 3, or greater than 4.

In some embodiments, the electrode material may have a volume fraction of metal is less than 20%, or less than 10%.

In some embodiments, the electrode material may have a surface area greater than 5 m²/g, or greater than 10 m²/g, or greater than 20 m²/g, or greater than 50 m²/g, or greater than 100 m²/g.

In some embodiments, the thickness of the metal coating may be less than 500 nm thick, or less than 200 nm thick, or less than 100 nm thick, or less than 50 nm thick, or less than 20 nm thick.

In some embodiments, the thickness of the metal and active material coating, taken together, is less than 500 nm thick, or less than 200 nm thick, or less than 100 nm thick, or less than 50 nm thick, or less than 20 nm thick.

In a second aspect, the present invention provides an electrode material comprising:

i) a metallic network structure, and
ii) an active material connected to the metallic structure,
wherein the calculated volume fraction of active material is greater than 5%, and the surface area of the material is greater than 5 m²/g.

In some embodiments, the metallic structure may have a volumetric surface area similar to the porous substrate. In these embodiments, the metal coating is essentially smooth. Thus in these embodiments the metal-coated material may also have a specific surface area of greater than 0.1 m²/cm³, or greater than 0.2 m²/cm³, or greater than 1 m²/cm³, or greater than 4 m²/cm³, or greater than 10 m²/cm³, or greater than 50 m²/cm³.

In some embodiments, roughness of the metal coating may lead to significantly enhanced surface area, compared to the porous substrate. By significantly enhanced we mean enhanced by a factor of 2 or more. Depending on the amount and size of roughness, this enhancement may be very significant. Thus the metal-coated material may also have a specific surface area of greater than 0.2 m²/cm³, or greater than 6 m²/cm³, more or greater than 30 m²/cm³, or greater than 120 m²/cm³, or greater than 300 m²/cm³, or greater than 1500 m²/cm³, or even up to 5,000 m²/cm³, or even up to 4,000 m²/cm³, or even up to 3,000 m²/cm³, or even up to 2,500 m²/cm³, or even up to 2000 m²/cm³.

The optimal surface area may vary depending on the exact application.

In some embodiments, the electrode material may have a calculated volume fraction of active material of greater than 30%, and a surface area of the material of greater than 20.m²/g material

In another aspect, the present invention provides an electrode material (such as a battery electrode material), characterised by a metallic network structure, and active material connected to the metallic structure, where the calculated volume fraction of active material is greater than 0.3 and the surface area of the material is greater than 20 m²/g.

The volume fraction of active material can be estimated two ways. The first is by direct mass measurement, where the mass of active material per unit volume is determined directly, and the volume fraction of active material per unit volume calculated by dividing by the density. The second method is an indirect method, where the capacity per unit volume is determined, and this is divided by the theoretical capacity per gram of active material to estimate the mass of active material per unit volume. Again, this is divided by density to estimate volume fraction of active material.

The surface area is determined via the BET (Brunauer, Emmett and Teller) method which is well known to those skilled in the art.

In a further aspect, the present invention provides an electrode material, characterised by a rated volumetric capacity of greater than 150 mAh/cc and maintaining a capacity of at least 80% of this capacity, for at least 1000 cycles at a charging and discharging rate of 5 C.

By rated capacity, we mean a specified capacity that the electrode should be operated at for a given rate.

In some embodiments, the electrode material has a rated volumetric capacity of greater than 200 mAh/cc, or greater than 250 mAh/cc, or greater than 400 mAh/cc, or greater than 600 mAh/cc, or greater than 800 mAh/cc, or greater than 1000 mAh/cc. Preferably, the electrode material maintains a capacity of at least 80% this capacity, for at least 1000 cycles, or 2000 cycles or 10000 cycles at a charging and discharging rate of 5 C. In some embodiments, the battery electrode material maintains a capacity of at least 80% of capacity for at least 1000 cycles at a charging and discharging rate of 10 C, more preferably 15 C, even more preferably, 30 C, even more preferably, 60 C, even more preferably, 120 C, even more preferably at a charging and discharging rate of from 15 C to 120 C.

In another aspect, the present invention provides an electrode material, characterised by a rated volumetric capacity of greater than 150 mAh/cc and maintaining a capacity of at least 80% of this capacity, for at least 1000 cycles, or 2000 cycles or 10000 cycles at a charging and discharging rate of 60 C. In some embodiments, the electrode material exhibits a rated volumetric capacity of greater than 200 mAh/cc, or greater than 400 mAh/cc, or greater than 500 mAh/cc, or greater than 600 mAh/cc, or greater than 800 mAh/cc, or greater than 1000 mAh/cc, and maintaining a capacity of at least 80% of this capacity, for at least 1000 cycles, more preferably greater than 2000 cycles or 10000 cycles, at a charging and discharging rate of 60 C.

In some embodiments, the electrode material exhibits a rated volumetric capacity of from 260 to 1100 mAh/cc, or from 300 to 1025 mAh/cc.

In a further aspect, the present invention provides an electrode material, characterised by a rated gravimetric capacity of greater than 50 mAh/g and maintaining a capacity of at least 80% of this capacity, for at least 1000 cycles, at a charging and discharging rate of 5 C. Throughout this specification, including examples, the gravimetric capacity is expressed per gram of electrode material, i.e. the mass includes both active battery material and conductive material.

In some embodiments, the electrode material exhibits a rated gravimetric capacity of greater than 100 mAh/g, or greater than 110 mAh/g, or greater than 150 mAh/g, or greater than 170 mAh/g, or greater than 200 mAh/g, or greater than 250 mAh/g, or greater than 300 mAh/g or up to 400 mAh/g. In some embodiments, the electrode material maintains a capacity of at least 80% of the capacity, for at least 2000 cycles, or for at least 10000 cycles. The battery electrode material may have these properties at a charging and discharging rate of 10 C, more preferably 15 C, even more preferably, 30 C, even more preferably, 60 C, even more preferably, 120 C, even more preferably at a charging and discharging rate of from 15 C to 120 C.

In a further aspect, the present invention provides an electrode material, characterised by a rated gravimetric capacity of greater than 50 mAh/g, or greater than 100 mAh/g, or greater than 110 mAh/g, or greater than 150 mAh/g, or greater than 170 mAh/g, or greater than 200 mAh/g, or greater than 250 mAh/g, or greater than 300 mAh/g, and maintaining a capacity of at least 80% of the capacity, for at least 1000 cycles, or 2000 cycles or 10000 cycles at a charging and discharging rate of 60 C.

In another aspect, the present invention provides an electrode material, characterised by a rated volumetric capacity of greater than 110 mAh/cc and maintaining a capacity of at least 80% of this capacity, for at least 1000 cycles of charge and discharge at a depth of discharge of greater than 30%.

Preferably, the electrode material has a rated volumetric capacity of greater than 200 mAh/cc, or greater than 260 mAh/cc, or greater than 300 mAh/cc or greater than 450 mAh/cc, or greater than 600 mAh/cc, or greater than 800 mAh/cc, or greater than 1000 mAh/cc. Preferably, the battery electrode material maintains a capacity of at least 80% of capacity, for at least 1000 cycles, or 2000 cycles or 10000 cycles, of charge and discharge at a depth of discharge of greater than 30%, or greater than 50%, or greater than 70%, or greater than 80%.

In a further aspect, the present invention provides an electrode material, characterised by a rated power density of greater than 2 W per cubic centimetre of electrode, and maintaining a power density of at least 80% of this power density, for at least 1000 cycles.

The power density is calculated using data from a flooded cell setup with a metal hydride anode, where the metal hydride anode is much larger than the nickel hydroxide cathode so that the power is not limited by the anode. The calculation uses the midpoint voltage of the discharge plateau multiplied by the discharge current, divided by the volume of the cathode.

In some embodiments, the electrode material exhibits a rated volumetric power density of greater than 2 W per cubic centimetre of electrode, or greater than 4 W per cubic centimetre of electrode, or greater than 20 W per cubic centimetre, or greater than 36 W per cubic centimetre of electrode, or greater than 45 W per cubic centimetre of electrode. In some embodiments, the electrode material maintains a power density of at least 80% of this power density, for at least 2000 cycles, or for at least 10000 cycles of charge and discharge.

In a further aspect, the present invention provides an electrode material, characterised by a rated specific power of greater than 1 W per g of electrode, and maintaining a power density of at least 80% of this specific power, for at least 1000 cycles.

The specific power is calculated using data from a flooded cell setup with a metal hydride anode, where the metal hydride anode is much larger than the nickel hydroxide cathode so that the power is not limited by the anode. The calculation uses the midpoint voltage of the discharge plateau multiplied by the discharge current, divided by the calculated total weight of the cathode including metal and estimated active material.

In some embodiments, the electrode material exhibits a rated specific power of greater than 2 W per g of electrode, or greater 4 W per g of electrode, or greater than 9 W per g of electrode, or greater than 16 W per g of electrode. In some embodiments, the electrode material maintains a specific power of at least 80% of this specific power, for at least 2000 cycles, or for at least 10000 cycles of charge and discharge.

In a further aspect, the present invention provides an electrode material, characterised by a rated gravimetric capacity of greater than 50 mAh/g and maintaining a capacity of at least 80% of capacity, for at least 1000 cycles of charge and discharge at a depth of discharge of greater than 30%.

In some embodiments, the electrode material exhibits a rated gravimetric capacity of greater than 100 mAh/g, or greater than 110 mAh/g, or greater than 150 mAh/g, or greater than 170 mAh/g, or greater than 200 mAh/g, or greater than 250 mAh/cc, or greater than 300 mAh/g. In some embodiments, the battery electrode material maintains a capacity of at least of this capacity, for at least 2000 cycles, or for at least 10000 cycles of charge and discharge at a depth of discharge of greater than 30%, or greater than 50%, or greater than 70%, or greater than 80%.

In a further aspect, the present invention provides an electrode material, the material maintaining a capacity of at least 80% of rated capacity for at least 500 cycles of charge and discharge, with the charge cycles being conducted at a charging and discharging rate of 0.5 C or greater.

In another aspect, the present invention provides an electrode material, the material maintaining a capacity of at least 80% of rated capacity for at least 500 cycles of charge and discharge at a depth of discharge of greater than 30%.

In a further aspect, the present invention provides an electrode material, the material exhibiting a charge/discharge efficiency of greater than 60% at a depth of discharge of greater than 30%.

In a further aspect, the present invention provides an electrode material, the material maintaining a capacity of at least 80% of rated capacity for at least 500 charge and discharge cycles at a depth of discharge of greater than 30%.

In some embodiments, significant amounts of active material may be present in the electrodes of the present invention in order to provide reasonable capacity. Surprisingly, these electrodes can be exposed to high rates of charge/discharge and high levels of DOD, and still maintain good cycling stability. The charge/discharge cycling at high rates can also exhibit high levels of charge/discharge efficiency.

By high rates of charge/discharge we mean higher than used in conventional operation of batteries. The rates of charge and discharge may be described in terms, of a ‘C’ rate. This is well known in art. The C rate is the inverse of the time, in hours, that is required to charge or discharge. For example, 0.1 C takes 1/0.1=10 hours to charge/discharge. In embodiments of the present invention, cycling may be performed at rates higher than 0.5 C, or higher than 1 C, or higher than 2 C, or higher than 5 C, or higher than 10 C, or higher than 20 C, or higher than 30 C or higher than 60 C, or higher than 1000, or higher than several hundred C.

By good cycling stability, we mean that the capacity is maintained above a certain percentage of full capacity, determined at the cycling charge/discharge rate, for more than 1000 cycles, or more than 1500 cycles, or more than 2000 cycles, or more than 5000 cycles, or more than 10000 cycles.

In order to calculate DOD, the rated capacity may be used as full capacity. By high DOD, we mean greater than 30%, or greater than 50%, or greater than 70%, or greater than 80% of full capacity.

By charge/discharge efficiency we mean the ratio, expressed as a percentage, between the capacity exhibited during discharge and the capacity exhibited during charge. By high discharge efficiency, we mean greater than 60%, or greater than 80%, or greater than 90%, or greater than 95%.

In some embodiments, the electrode materials of the present invention are comprised of thin film coatings of metal that are configured in such a way as to provide a porous structure.

In some embodiments, the electrode materials of the present invention are comprised of a thin film of metallic conducting material that is present in a form that creates a complex porous structure. By complex pore structure, we mean a pore structure that varies significantly in terms of pore size, or pore shape, or comprises of pores that follow a tortuous path, or combinations of these. In further embodiments, at least part of this conducting material is converted to active material. In other embodiments, active material is deposited on the conducting material. In other embodiments, active material may be provided by a combination of at least partially activating the conducting material, and deposition of further active material.

In some embodiments, a porous substrate, such as a porous polymeric substrate, is provided and the metal and active material layers or coatings are formed on the porous substrate. The porous substrate may optionally be removed after forming the metal and active material coatings or layers thereon.

In some embodiments, the porous structure may be comprised of a fibrous network or substrate or at least partially comprised of fibres. In some embodiments, the fibres may be polymeric. The fibrous substrate may also be a complex structure, by which we mean that the structure may be comprised of fibres of varying diameter and/or length, the fibres may follow tortuous or complex paths, and the porous space defined by the fibres may be irregular in terms of both size and shape. The electrode may be comprised of a fibrous network coated with a metal or metal alloy, with a further coating or layer of active material.

In some embodiments, the electrodes of the present invention may be comprised of thin coatings of metal, configured in such a way as to make a porous structure.

In some embodiments, the electrodes of the present invention may begin with materials described in our co-pending international patent application number PCT/AU2012/000266 or in our co-pending international patent application number PCT/AU2010/001511, or in our co-pending international patent application number PCT/AU2013/000088, the entire contents of which are here incorporated by cross-reference.

The inventors have found that these starting materials may be activated to an extent that provides good capacity, and surprisingly that good capacity may be maintained over a large number of cycles during charging and discharging at high rates and also high DOD.

In other embodiments, materials similar to those described in our co-pending international patent application number PCT/A112012/000266 may be used as a starting point from which to deposit active material. In further embodiments, more active material is deposited, then at least part of the starting material may also be converted to active material.

In some embodiments, the battery electrode material comprises a porous electrode material. The porous electrode material may have a specific surface area of greater than 0.1 m²/cm³, more preferably greater than 0.2 m²/cm³, more preferably greater than 1 m²/cm³, even more preferably greater than 4 m²/cm³, further preferably greater than 10 m²/cm³, even further preferably greater than 50 m²/cm³. Higher surface area electrodes may have an advantage in that thin films of material can be used, which are advantageous to rate, whilst still maintaining a good volume fraction of material which enables good capacity.

In some embodiments, the coating of metal may comprise a thin coating. For, example, the coating may be less than 500 nm thick, or preferably less than 200 nm thick, even more preferably less than 100 nm thick, even more preferably less than 50 nm thick, or less than 20 nm thick. The optimum thickness may vary for different battery types or applications. For example, a thinner coating may provide faster charge/discharge rates, but lower capacity, compared to a thicker coating. This may be desirable for some applications. For other applications, capacity may have greater relative importance thus a thicker coating may be desirable.

In some embodiments, the thickness of the metal and active material coating, taken together, may be less than 500 nm thick, or less than 200 nm thick, or less than 100 nm thick, or less than 50 nm thick, or less than 20 nm thick.

In some embodiments, the coating of metal may be a thin coating, and after activation, there may be sufficient volume fraction of active material to give good capacities per unit volume, and energy density per unit volume. For example, the volume fraction of active material may be greater than 10%, or greater than 20%, or greater than 35%, or greater than 50%, or greater than 60%.

In further embodiments, after activation, there may be sufficient volume fraction of active material to give good capacities per unit volume, and energy density per unit volume, and the remaining amount of metal may be thin, in order to give good capacities and energy densities per unit weight. For example, an average metal thickness remaining may be less than 80 nm, or less than 50 nm, or less than 20 nm, or less than 12 nm.

In some embodiments, the pore structure of the electrode enables good permeability. This allows ions to move in and out of the structure with reduced resistance, again improving rate capability.

In some embodiments, the electrode is a nickel-based cathode material. The starting material may contain significant amounts of nickel, nickel oxide, nickel oxyhydroxide and nickel hydroxide. Activation may increase the amounts of nickel oxide, nickel oxyhydroxide or nickel hydroxide or mixtures of these. When operating as a cathode material in a nickel-based battery, the active material may cycle between different oxidation states, for example between nickel oxyhydroxide and nickel hydroxide during charging and discharging. Preferably, after activation, sufficient nickel remains to provide enhanced conductivity. In these and other embodiments, further elements may be added to increase performance. For example, in nickel-based cathode materials, elements such as cobalt and zinc may be added to improve properties such as utilisation, charge/discharge stability, and shifting the voltage required for oxygen generation to higher voltage to reduce gas generation. Other additives are known to those skilled in the art. These added elements may be present such that they are essentially homogeneously dispersed, alternatively they may begin as a surface layer, or may begin as layers throughout the nickel-based material. Some additive elements may also be added from solution, during activation or during cycling.

Any suitable active material may be used in the present invention. Examples include nickel oxide, cobalt oxide, tin oxide, nickel hydroxide, nickel oxyhydroxide, copper oxide, iron oxide, manganese oxide, manganese oxyhydroxide, zinc and zinc hydroxide, cadmium and cadmium hydroxide, iron and iron hydroxide, tin, tin oxide, tin alloys and tin composites, silicon and silicon composites, antimony and antimony oxide, sulfur and metal sulphides.

Anode materials for lithium ion batteries include tin-based materials, including alloys and mixtures of tin with other metals such as copper, nickel, cobalt, antimony and the like, and combinations of these. Metal oxides such as nickel oxide, iron oxide, copper oxide, cobalt oxide, chromium oxide, ruthenium oxide, tin oxide, manganese oxide, lithium oxide, aluminium oxide, vanadium oxide, molybdenum oxide, titanium oxide, niobium oxide, antimony oxide, silicon oxide, germanium oxide, zinc oxide, cadmium oxide, indium oxide, metal borates, metal oxysalts, lithium titanates and the like, and combinations of these, may also be used. Carbon and mixtures of carbon with other anode materials may also be used. Materials containing lithium metal and silicon may also be used.

Cathode materials for lithium ion batteries are also suitable materials for use in the present invention. Some common materials such as lithium manganese oxides, lithium nickel oxides, lithium cobalt oxides, lithium iron phosphates, doped lithium iron phosphates, so-called ‘high energy nickel manganese-based compounds, and the like, and mixtures of these, may be employed in the present invention. Other materials such as silicate compounds (Li₂MSiO₄, M=Fe, Mn, etc.), tavorite compounds (LiMPO₄F, M=V, Fe, etc.), borate compounds (LiMBO₃, M=Mn, Fe, Co, etc.) may also be employed in the present invention. Lithium metal may also be employed as a cathode material.

In some embodiments, the coating may also contain a seed layer of material. In some embodiments, the seed layer is a copper-based seed layer, which may be used to seed deposition of a nickel-based material to form the final coating. Preferably the seed layer is thin, particularly if the material is inactive. The seed layer may preferably be less than 20 nm thick, or less than 10 nm thick, or less than 5 nm thick.

In some embodiments the coating may be at least partially comprised of a fine-grained structure. By fine-grained structure we mean that the crystallite grain size is small. The grain size may be less than 100 nm, or less than 50 nm, or less than 20 nm, or less than 10 nm.

In some embodiments the coating may be at least partially comprised of regions that are essentially amorphous. For example, some nickel-phosphorus and nickel-boron alloys deposited via electroless deposition may contain significant regions of amorphous material.

In some embodiments the electrode is of sufficient thickness to provide useful capacity per unit area. The thinner an electrode, the less volume it has, and therefore less capacity per unit area. Thinner electrodes require more electrodes in a stack to provide a certain capacity. Thicker electrodes can be advantageous in batteries as the relative volume of separator material is reduced, thereby the energy density of the entire battery is increased. In some embodiments, the electrodes are greater than 1 um thick, or greater than 10 μm thick, or greater than 80 um thick, or greater than 200 um thick, or greater than 400 um thick.

In some embodiments the electrode materials deliver high power per unit volume and per unit weight, through fast discharging. In providing such power output, the electrode may be charged at a similar rate, or a different rate, for example a slower rate. In some embodiments the electrode may be discharged at a rate greater than 5 C, or greater than 10 C or greater than 20 C, or greater than 60 C.

Many variations of the invention may be envisaged. For example, the electrode may be a cathode or an anode. A matching electrode pair, meaning both cathode, and anode, may be prepared according to the present invention in order to maximise the benefits to a battery's performance. For example, a nickel hydroxide-based cathode material may be matched to a zinc-based anode for a nickel-zinc battery, or matched to a metal hydride based anode for a nickel-metal hydride battery, or a cadmium-based anode for a nickel-cadmium battery, or an iron-based anode for nickel-iron battery.

Alternatively an electrode of the present invention may be incorporated with a conventional counter electrode in a battery.

Any suitable active materials may be incorporated into the electrodes of the present invention. For example, cathode materials for lithium ion batteries may include materials based on lithium manganese oxide, lithium nickel oxide, lithium cobalt oxides, or mixtures of these, lithium iron phosphate materials, various doped versions of lithium iron phosphates, so-called high energy nickel-manganese oxide based materials, sulphur-based materials, vanadium oxide, and composites of these. Anode materials for lithium ion batteries include carbon-based materials such as graphite, tin and tin composites or alloys, silicon and silicon composites or alloys. Cathode materials for nickel-based batteries include nickel hydroxides and oxyhydroxides, as well as doped or mixed composites of these where dopants may include zinc, cobalt, and other metals, as well as oxides of these. Anode materials for nickel-based batteries include metal hydrides, iron, zinc or mixtures or composites of these.

The electrode materials of the present invention may be used in electrodes used in batteries. The electrode materials of the present invention may also be used in capacitors, supercapacitors or so-called ‘pseudo-capacitors’. By pseudo-capacitor, we mean that at least one electrode may operate by shallow insertion of ions into the structure. This is distinct from a true capacitor, where both electrodes operate via a charged ‘double-layer’ at the surface of the electrode in the electrolyte. The pseudo-capacitor electrode is distinct from a battery electrode mainly by the depth of insertion of ions. For example, a nickel-based electrode of the present invention may be combined with a carbon-based electrode to form a nickel carbon capacitor.

In another embodiment, the present invention provides an electrode material wherein the ratio of the gravimetric capacity at 10 C to the maximum achievable gravimetric capacity at 2 C is greater than 70%, and the electrode material can maintain greater than 75% of its capacity after cycling for more than 1000 cycles. In one embodiment, the ratio of the gravimetric capacity at 60 C to the maximum achievable gravimetric capacity at 2 C is greater than 60%, and the electrode material can maintain greater than 75% of its capacity after cycling for more than 1000 cycles. In another embodiment, the ratio of the gravimetric capacity at 120 C to the maximum achievable gravimetric capacity at 2 C is greater than 50%, and the electrode material can maintain greater than 75% of its capacity after cycling for more than 1000 cycles. In a further embodiment, the ratio of the gravimetric capacity at 240 C to the maximum achievable gravimetric capacity at 2 C is greater than 40%, and the electrode material can maintain greater than 75% of its capacity after cycling for more than 1000 cycles. In some embodiments, the electrode material can maintain greater than 75% of its capacity after cycling for more than 2000 cycles, or more than 5000 cycles.

In another embodiment, the present invention provides an electrode comprising a nickel-containing compound, where the capacity of the electrode per gram of electrode, calculated as the total weight of the electrode, is greater than 100 mAh at 240 C discharge rate. In one embodiment, the capacity of the electrode per gram of electrode, calculated as the total weight of the electrode, is greater than 120 mAh at 120 C discharge rate. In another embodiment, the capacity of the electrode per gram of electrode, calculated as the total weight of the electrode, is greater than 130 mAh at 60 C discharge rate. In another embodiment, the capacity of the electrode per gram of electrode, calculated as the total weight of the electrode, is greater than 140 mAh at 10 C discharge rate. The electrode may maintain at least 80% of its capacity at the specified discharge rate, after charge/discharge cycling for greater than 1000 cycles at the specified discharge rate. The electrode material may maintain at least 80% of its capacity at the specified discharge rate, after charge/discharge cycling for greater than 5000 cycles at the specified discharge rate. The electrode may maintain at least 80% of its capacity at the specified discharge rate, after charge/discharge cycling for greater than 10,000 cycles at the specified discharge rate.

The specific power of the electrode, calculated from the total weight of the electrode, may be greater than 2 W/g or 5 W/g or 10 W/g or 20 W/g.

The invention also relates to new methods of activating electrode materials. By activating, we mean a process for increasing the amount of active electrode material present, thereby increasing the capacity of the battery. In conventional nickel-based electrodes, active material is already present in the electrode. The electrodes are subjected to a ‘formation’ process, 0.15 typically a few cycles (1-5) of charge and discharge at low rates (˜0.1 C to 0.2 C). By 0.1 C, we mean that the time to charge is 1/0.1=10 h. Similarly by 0.2 C, we mean the time to charge or discharge is 1/0.2=5 h. This C nomenclature to describe charge and discharge rates is well known to those skilled in the art. During the formation process, active material already present is activated, however significant creation of new active material does not occur. Conventional formation processes can therefore take considerable time, eg. 3 cycles at 0.2 C takes 30 h. The inventors have found that some materials of the present invention may be activated to a much higher extent than using standard methods of formation by charging and discharging at much higher rates. This can also enable much faster activation. The inventors believe that at least part of this benefit may derive by application of higher voltages. Therefore some embodiments of the invention may comprise activation at constant, higher voltages, or some voltage profiles with time that utilise higher voltages. A period of time for soaking of electrolyte may also be advantageous before or during the activation. By soaking we mean that the electrode is immersed in the electrolyte for a period of time without charging or discharging. The use of such soak times before formation processes are known in the art. In the present invention, the soak times may be advantageously used prior to, or during the activation process. For example, the activation cycles may be stopped for a certain period of time to allow for soaking, after which cycling may be re-commenced.

According to a further embodiment, the present invention provides a method for activating a battery electrode material comprising the steps of preparing the material and subjecting the material to at least one cycle of charge and discharge at least 2 C. In some embodiments, the material is activated by subjecting the material to at least one cycle of charge and discharge at a charge and discharge rate of higher than 5 C, or higher than 10 C, or higher than 15 C, or higher than 20 C, or higher than 30 C, or higher than 60 C, or higher than 100 C, or higher than several hundred C. In some embodiments, the material is activated by subjecting it to two cycles of charge and discharge at the charging rates mentioned above, or to 3 cycles of charge or discharge, or 5 cycles of charge or discharge, or 10 cycles of charge or discharge or more than 10 cycles of charge or discharge.

In some embodiments, the material is activated by subjecting it to a first series of charge and discharge cycles at a specified charging rate, followed by a second series of charge and discharge cycles at a higher charging rate. In other embodiments, the material may be subject to a third series of charge and discharge cycles at an even higher charging rate.

In some embodiments activation may occur after the cell is assembled. In other embodiments, activation can occur prior to assembly, for example in a flooded-cell type arrangement.

In some embodiments, the electrodes of the present invention are free standing. This means that the electrodes are self-contained, i.e. are not intimately connected to another material, for example a thin foil of solid metal or some other substrate material. Such free standing electrodes can have several advantages for batteries, including simpler processing, and reduced weight and volume that lead to higher overall capacities.

In some embodiments, the electrode may contain a certain ratio of volume of active material to volume of metallic material. In some applications, a high ratio of volume of active material to volume of metallic material may be desirable as a higher ratio increases the overall capacity of the battery, relative to total mass. For example, a calculated ratio of volume of active material to volume of metallic material is greater than 1.5, preferably greater than 3, even more preferably greater than 4.

In some embodiments, the volume fraction of metal in the electrode is a certain amount. For some applications it may be advantageous to have a lower volume fraction of metallic material, in order to increase the ratio of active material to metallic material, thereby increasing capacity. For example, the volume fraction of metallic material may be less than 20%, or less than 10%.

In some embodiments, the surface area of the material is a certain value. Higher surface areas can be advantageous, as thinner coatings of active material may be used in order to achieve a certain volume fraction of active material. Thus rate performance is increased. Also, contact with ions in the electrolyte may be increased. For example, the surface area of the electrode may be greater than 5 m²/g, or greater than 10 m²/g, or greater than 20 m²/g, or greater than 50 m²/g, or greater than 100 m²/g.

Any suitable method may be used to make the electrodes of the present invention. For example, methods outlined in our co-pending international patent application number PCT/AU2012/000266 or in our co-pending international patent application number PCT/AU2010/001511 or in our co-pending international patent application number PCT/AU2013/000088 may be used.

### BRIEF DESCRIPTION OF THE DRAWINGS

FIG. 1. Capacity vs number of charge/discharge cycles for charging and discharging at 15 C, for the material in example 2.

FIG. 2. Capacity vs number of charge/discharge cycles for charging and discharging at 30 C, for the material in example 3.

FIG. 3. Capacity vs number of charge/discharge cycles for charging and discharging at 60 C, for the material in example 4.

FIG. 4. Capacity vs number of charge/discharge cycles for charging and discharging at 60 C, for the material in example 5.

FIG. 5. Capacity vs number of charge/discharge cycles for charging and discharging at 60 C, for the material in example 6.

FIG. 6. Capacity vs number of charge/discharge cycles for charging at 20 C and discharging at 60 C, for the material in example 8.

FIG. 7. Capacity vs number of charge/discharge cycles for charging at 20 C and discharging at 120 C, for the material in example 13.

FIG. 8. Capacity vs number of charge/discharge cycles for cycling at 30% DOD, for the material in example 14.

FIG. 9. SEM images and EDS results for the material in example 17.

FIG. 10. SEM images and EDS results for the material in example 18.

### EXAMPLES

By way of example, the following are various embodiments of the invention.

### Example 1

Nickel (Ni) was coated on a 0.45 μm cellulose acetate filter membrane using electroless deposition. The surface area of this substrate is estimated at ˜2.3 m²/cc. The volume fraction of polymer is about 34%. The membrane was coated with a seed layer prior to electroless deposition. Weight measurements showed that the average thickness of the Ni coating was about 70 nm.

This sample was mounted in a flooded cell with a metal hydride counter electrode and an aqueous electrolyte with 6M potassium hydroxide and 1 wt % lithium hydroxide.

The material was activated using a conventional procedure by cycling at 0.2 C. After 3 cycles the capacity was ˜67.5 mAh/cc.

The material was further activated by cycling at higher rates. After 8 cycles at 5 C, the capacity was ˜234 mAh/cc. After further 6 cycles at 10 C, the capacity was ˜245 mAh/cc. After further 4 cycles at 20 C, the capacity was 249.7 mAh/cc. After a further 20 cycles at 10 C, the capacity was 270 mAh/cc. After a further 60 cycles the capacity was ˜290 mAh/cc. The gravimetric capacity was estimated at ˜160 mAh/g. Using the theoretical capacity of Ni(OH)₂ of 289 mAh/g and density of 4.1 g/cc, the volume of Ni(OH), is estimated at 0.243 cc Ni(OH)₂ per cc of total volume. In other words, the volume fraction of Ni(OH)₂ in the electrode is estimated at 24.3%. The average estimated thickness of leftover nickel is about 35 nm. Clearly the higher rate cycles have resulted in substantial increase in capacity from the conventional activation.

### Comparative Example 1

A sample was prepared similarly to example 1, however activation was via flow of 50% hydrogen peroxide for 15 mins. Following this activation, the material was further subjected to a ‘standard’ activation of two cycles at 0.2 C. Following this activation, the discharge capacity was ˜142 mAh/cc. Clearly this activation provided much less active material than for the case of the activation in example 1. Furthermore, this material was further cycled for 2 cycles each at 0.5 C, 1 C, 2 C and 5 C. Following this, the discharge capacity was reduced to ˜74 mAh/cc. Clearly further cycling at these low rates did not improve capacity.

### Comparative Example 2

A sample was prepared similarly to example 1, however activation was via anodization that was conducted via flow through of a solution consisting of 0.5 M NiSO₄, 0.5 M Na₂SO₄ and 0.5 M CH₃COONa. Anodic pulses (1.7 V, is on, 4 s off, 1.5 h deposition time) were applied to the Ni coated membrane sample using a stainless steel counter-electrode at room temperature. Following this activation, the material was further subjected to a ‘standard’ activation of three cycles at 0.2 C. Following this activation, the discharge capacity was only ˜72 mAh/cc. Clearly this activation provided much less active material than for the case of the activation in example 1.

### Example 2

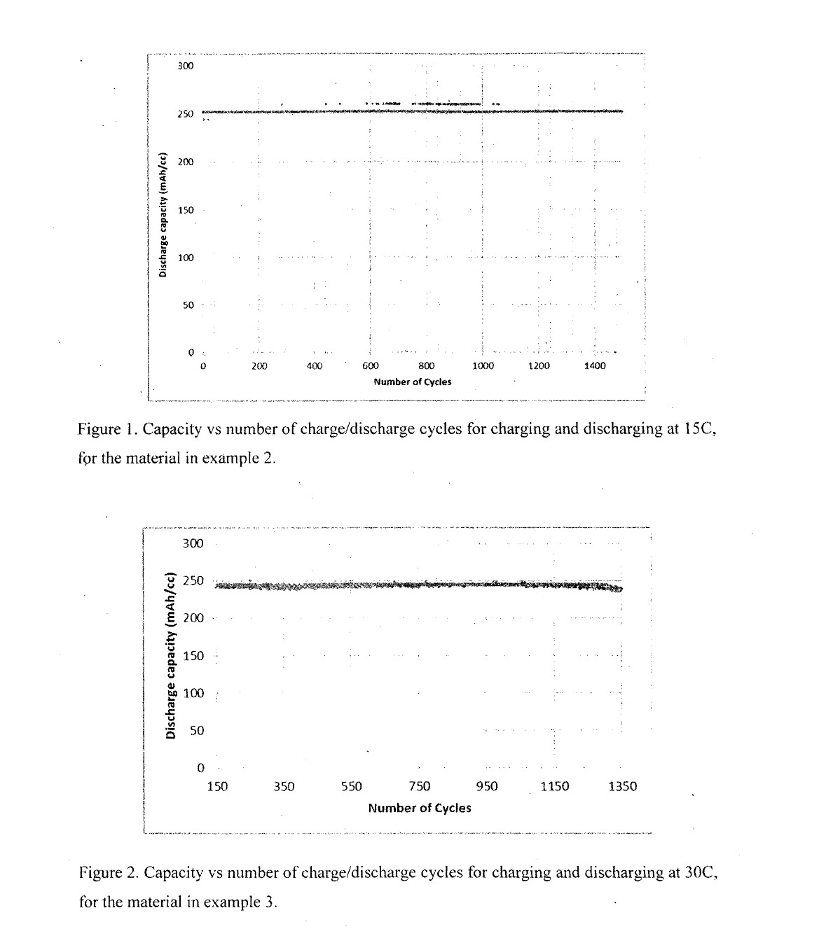

Material was prepared in a similar manner to Example 1. The estimated thickness of nickel was 58 nm. The sample was initially activated by 11 cycles at 5 C, to give a discharge capacity of ˜189 mAh/cc. The sample was further activated by 11 cycles at 10 C to give a discharge capacity of ˜221 mAh/cc, then 10 cycles at 15 C to give a discharge capacity of ˜228 mAh/cc, then a further 30 cycles at 15 C to give a discharge capacity of ˜252 mAh/cc. The gravimetric discharge capacity was estimated as ˜143 mAh/g. The material was then cycled at 15 C at ˜100% DOD. FIG. 1 shows the capacity vs number of cycles at 15 C. Clearly the material is stable at 15 C. Discharging at 15 C gives power densities of ˜3.8 W/cc and ˜2.1 W/g, calculated using an average discharge voltage of 1V.

### Example 3

Material was prepared a similar manner to Example 1. The nickel thickness was estimated at 70 nm. The sample was initially activated at 5 C. After the 10^{th} cycle the discharge capacity was 231 mAh/cc. The gravimetric discharge capacity was estimated as ˜118 mAh/g. FIG. 2 shows the capacity vs number of cycles at 30 C. Clearly the material is stable at 30 C. Discharging at 30 C gives power densities of ˜7 W/cc and ˜3.5 W/g, calculated using an average discharge voltage of 1V.

### Example 4

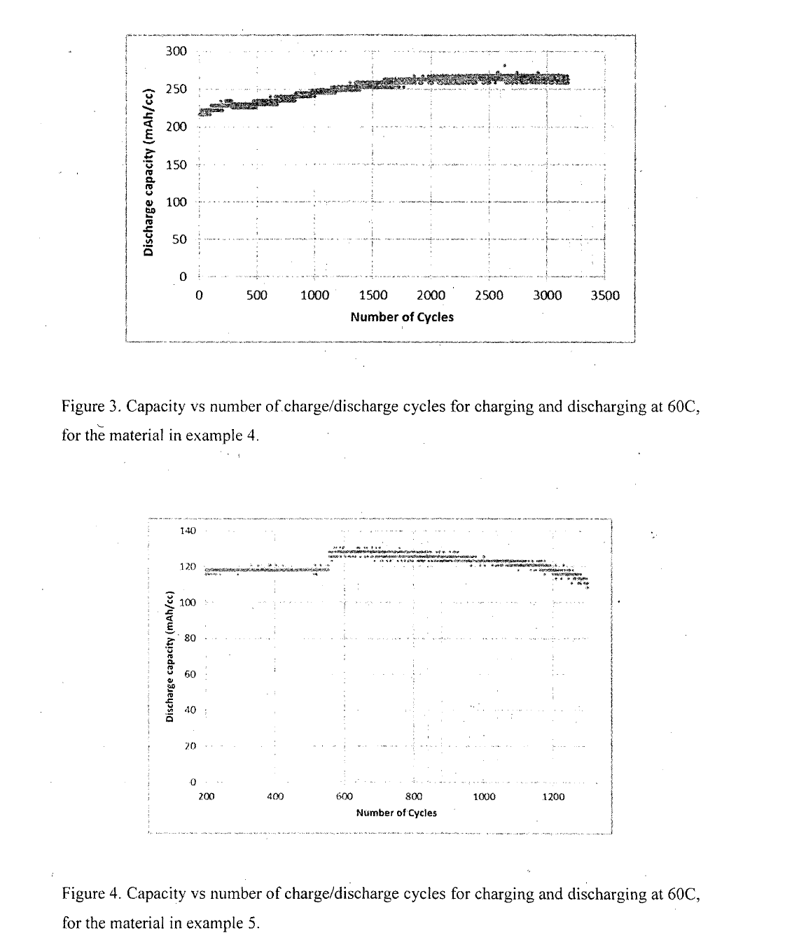

Material was prepared in a similar manner to Example 1. The thickness of the nickel was estimated at 75 nm. The material was initially activated for 11 cycles at 5 C, giving a discharge capacity of 87 mAh/cc. A further 11 cycles at 10 C then 151 cycles at 15 C increased discharge capacity to 150 mAh/cc. After a further 500 cycles at 60 C the discharge capacity was 189 mAh/cc. This corresponds to an estimated gravimetric discharge capacity of 95 mAh/g. FIG. 3 shows the capacity, vs number of cycles at 60 C. Clearly the material is stable at 60 C. The volumetric capacity increased to ˜270 mAh/cc, which corresponds to an estimated gravimetric discharge capacity of ˜136 mAh/g. Discharge at 60 C results in power densities of ˜16 W/cc and ˜8 W/g, calculated using an average discharge voltage of 1V.

### Example 5

Material was prepared in a similar manner to Example 1. The thickness of the nickel was estimated at 70 nm. The material was activated for 11 cycles at 5 C, giving a discharge capacity of ˜94.5 mAh/cc. The material was then cycled at 60 C. After a further 150 cycles at 60 C the discharge capacity increased to ˜18 mAh/cc. After ˜600 cycles the amount of charge was increased which increased discharge capacity to ˜128 mAh/cc. This corresponds to an estimated gravimetric capacity of 96 mAh/g. FIG. 4 shows the capacity vs number of cycles at 60 C, including the increased charge. Clearly the material is stable at 60 C. Discharging at 60 C results in power densities of ˜8 W/cc and ˜6 W/g, calculated using an average discharge voltage of 1V.

### Example 6

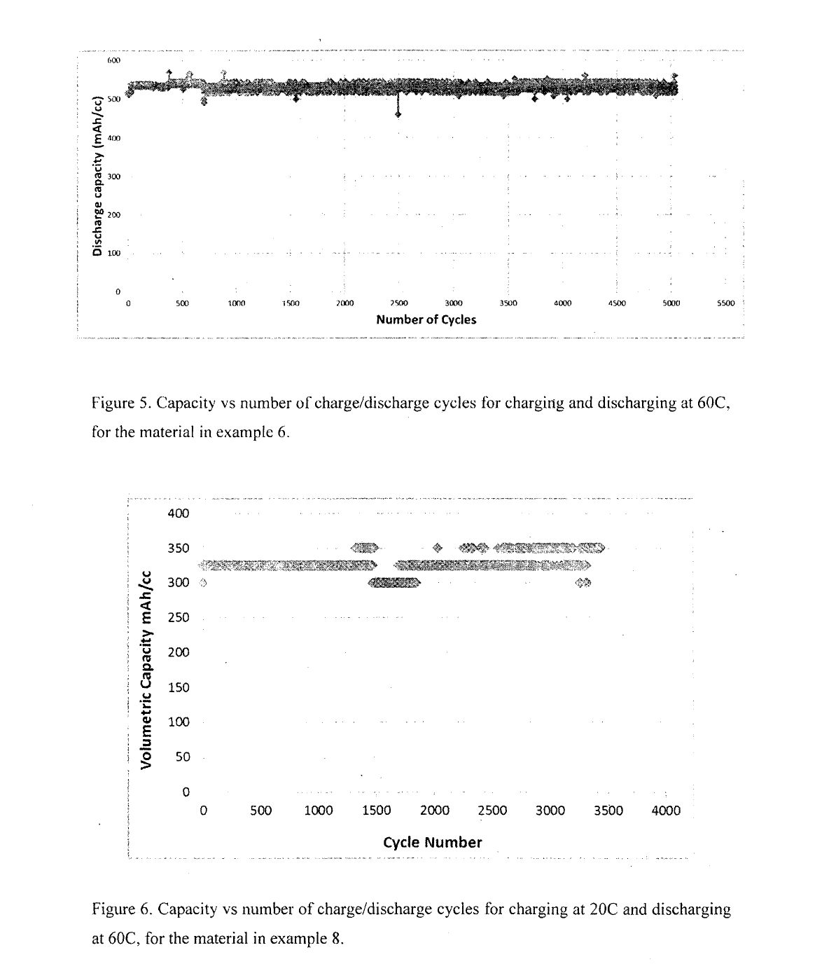

Material was prepared in a similar manner to previous examples, except the thickness of the nickel sample was estimated to be ˜130 nm. The sample was activated by cycling at 15 C, whereupon the discharge capacity was estimated at 525 mAh/cc and 155 mAh/g. Using the theoretical capacity of Ni(OH)₂ of 289 mAh/g and density of 4.1 g/cc, the volume of Ni(OH)₂ is estimated at 0.44 cc Ni(OH)₂ per cc of total volume. In other words, the volume fraction of Ni(OH)₂ in the electrode is estimated at 44%. %. An estimated average thickness of remaining nickel metal is about 65 nm. FIG. 5 shows the capacity vs number of cycles at 60 C. Clearly the material is stable at 60 C. Discharging at 60 C results in power densities of ˜31 W/cc and ˜9.3 W/g, calculated using an average discharge voltage of 1V.

### Example 7

Material was prepared in a similar manner to previous examples, except the thickness of the nickel sample was estimated to be ˜100 nm. After cycling for 6000 cycles at 15 C the discharge capacity was estimated at 600 mAh/cc and 200 mAh/g. Using the theoretical capacity of Ni(OH)₂ of 289 mAh/g and density of 4.1 g/cc, the volume of Ni(OH)₂ is estimated at 0.51 cc Ni(OH)₂ per cc of total volume. In other words, the volume fraction of Ni(OH)₂ in the electrode is estimated at 51.6%. An estimated average thickness of remaining nickel metal alloy is about 27 nm. The Volume fraction of nickel metal alloy was estimated at 12%. Thus the ratio of volume fraction of active material to nickel metal alloy is about 4.3

### Example 8

A membrane comprised of an interconnected network of polymer fibres was coated with nickel in a similar manner to previous examples. The thickness of the membrane was approximately 40 micrometres. The weight of the nickel coating was approximately 0.0094 g/cm² or 2.35 g/cm³. The surface area of this membrane was estimated to be approximately 1 m²/cc. The average thickness of the nickel coating was estimated as 208 nm.

The sample was activated by cycling via cyclic voltammetry for 800 cycles then charged and discharged at 10 C then 20 C. The discharge capacity was estimated as 138 mAh/g and 325 mAh/cc. An estimated thickness of remaining nickel metal was about 120 nm.

FIG. 6 shows cycling data for 20 C charge and 60 C discharge.

### Example 9

Nickel coated material was prepared in a similar manner to previous examples. The sample was activated using cyclic voltammetry then charging and discharging at 10 C. The volumetric capacity was 504 mAh/cc.

After activation the surface area of this material was determined to be 83.7 m²/g.

### Example 10

Material was prepared in a similar manner to Example 1. The estimated thickness of nickel was about 97 nm. The sample was activated by cycling via cyclic voltammetry for 1600 cycles at 20 mV/s and then charging and discharging at a 10 C rate. The sample was then tested with various charge and discharge rates, the volumetric and gravimetric capacities, power densities and specific powers are shown in Table 1.

TABLE 1
Capacities at various charge and discharge rates

| | Sample | | Gravimetric | | | | |
|---|---|---|---|---|---|---|---|
| | (1×1 cm) | Volumetric | capacity | Specific | Specific | Energy | Power |
| | capacity | capacity | (mAh/g- | Energy | Power | Density | Density |
| C rate | (mAh) | (mAh/cc) | electrode) | (Wh/kg) | (W/g) | (Wh/cc) | (W/cc) |
| 10C/120C | 6.4 | 504 | −172 | 113 | 12.4 | 333 | 36.4 |
| 10C/60C | 7 | 551 | −184 | 125 | 8.9 | 392 | 28.2 |
| 10C/10C | 7.5 | 591 | −194 | 191 | 2.1 | 612 | 6.7 |
| 2C/2C | 9.6 | 756 | −232 | 273 | 1.0 | 889 | 3.2 |

Using the capacity for 10 C discharge (194 mAh/g) the ratio of active material to nickel metal was estimated at 3.34

### Example 11

A membrane comprised of an interconnected network of polymer fibres was coated with nickel in a similar manner to previous examples. The thickness of the membrane was approximately 85 micrometres. The surface area of this membrane was estimated to be about 0.86 m²/cc. The weight of the nickel coating was approximately 0.0145 g/cm² or 1.71 g/cm³. The average thickness of the nickel coating was estimated as 188 nm.

The sample was activated by cycling via cyclic voltammetry for 1600 cycles at 20 mV/s and then charging and discharging at a 10 C rate. Table 2 shows the volumetric and gravimetric capacities, power densities and specific powers of the sample at various charge and discharge rates.

TABLE 2
Capacities at various charge and discharge rates

| | Sample | | Gravimetric | | | | |
|---|---|---|---|---|---|---|---|
| | (1×1 cm) | Volumetric | capacity | Specific | Specific | Energy | Power |
| | capacity | capacity | (mAh/g- | Energy | Power | Density | Density |
| C rate | (mAh) | (mAh/cc) | electrode) | (Wh/kg) | (W/kg) | (Wh/cc) | (W/cc) |
| 10C/240C | 2.6 | 306 | ~114 | 40 | 14.4 | 107 | 38.5 |
| 10C/120C | 3.11 | 366 | ~133 | 102 | 15.4 | 282 | 42.4 |
| 10C/60C | 3.35 | 394 | ~141 | 137 | 10.3 | 382 | 28.7 |
| 10C/10C | 3.9 | 459 | ~160 | 162 | 2.1 | 467 | 6.0 |
| 2C/2C | 4.45 | 524 | ~177 | 216 | 0.4 | 641 | 1.3 |

### Example 12

A membrane comprised of an interconnected network of polymer fibres was coated with nickel in a similar manner to previous examples. The thickness of the membrane was approximately 40 micrometres. The surface area of this membrane was estimated to be about 1.02 m²/cc. The weight of the nickel coating was approximately 0.0073 g/cm² or 1.83 g/cm³. The average thickness of the nickel coating was estimated as 201 nm.

The sample was activated by cycling via cyclic voltammetry for 1600 cycles at 20 mV/s and then charging and discharging at a 10 C rate. Table 3 shows the volumetric and gravimetric capacities, power densities and specific powers of the sample at various charge and discharge rates.

TABLE 3
Capacities at various charge and discharge rates

| | Sample | | | | | | |
|---|---|---|---|---|---|---|---|
| | (1×1 cm) | Volumetric | Gravimetric | Specific | Specific | Energy | Power |
| C rate | capacity | capacity | capacity | Energy | Power | Density | Density |
| 10C/240C | 1.32 | 330 | ~118 | 50 | 16.2 | 139 | 45.3 |
| 10C/120C | 1.49 | 372.5 | ~131 | 102 | 14.8 | 291 | 42.0 |
| 10C/60C | 1.58 | 395 | ~137 | 131 | 8.9 | 375 | 25.6 |
| 10C/10C | 1.76 | 440 | ~150 | 164 | 1.8 | 480 | 5.3 |
| 2C/2C | 3.8-4.1 | ~1025 | ~279 | 307 | 0.7 | 1112 | 2.4 |

### Comparative Example

A cathode was removed from a commercial nickel metal hydride battery and tested in a similar way.

Table 4 shows the volumetric and gravimetric capacities, power densities and specific powers of the sample at various charge and discharge rates.

| | | | Gravimetric | | | | |
|---|---|---|---|---|---|---|---|
| | | Volumetric | capacity | Specific | Specific | Energy | Power |
| | | capacity | (mAh/g- | Energy | Power | Density | Density |
| C rate | (mAh) | (mAh/cc) | electrode) | (Wh/kg) | (W/kg) | (Wh/cc) | (W/cc) |
| 10C/60C | Nil | Nil | Nil | Nil | Nil | Nil | Nil |
| 10C/10C | 9.86 | ~110 | ~32 | 20 | 0.9 | 68 | 3.0 |
| 1C/1C | 40.8 | ~453 | ~133 | 149 | 0.1 | 508 | 0.5 |

Clearly the comparative electrode loses a lot of capacity as the discharge rate is increased.

### Example 13

A membrane comprised of an interconnected network of polymer fibres was coated with nickel in a similar manner to previous examples. The thickness of the membrane was approximately 40 micrometres. The surface area of this membrane was estimated to be about 1.02 m²/cc. The weight of the nickel coating was approximately 0.0073 g/cm² or 1.83 g/cm³. The average thickness of the nickel coating was estimated as 2.01 nm.

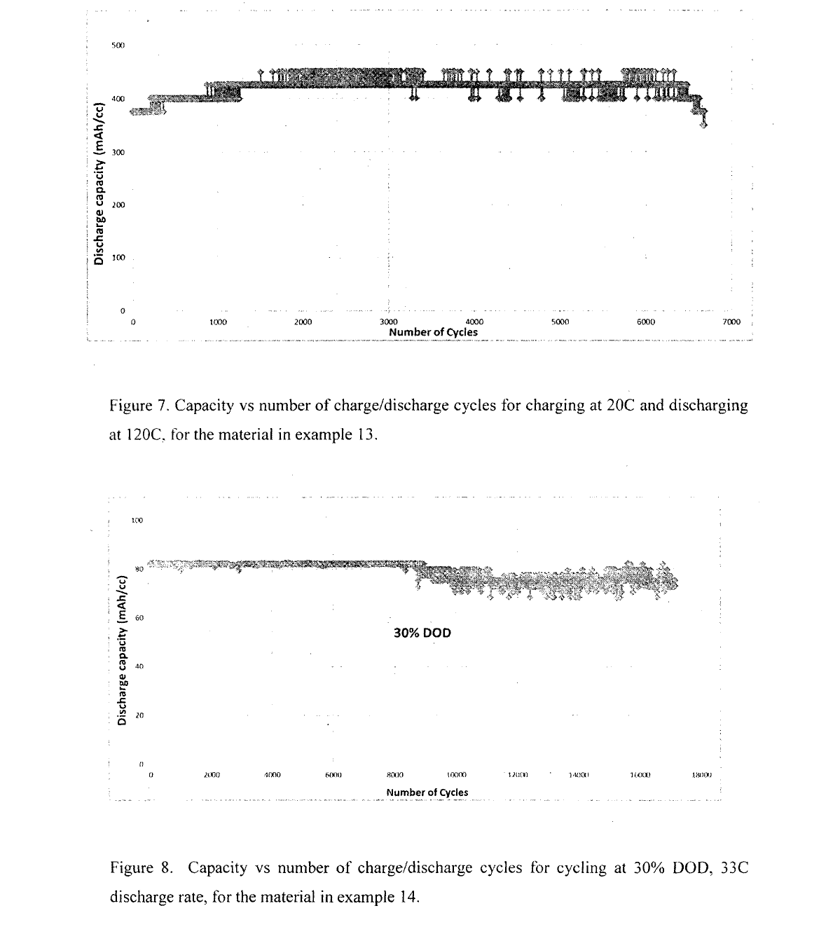

The sample was activated by cycling via cyclic voltammetry for 1600 cycles at 20 mV/s and then charging and discharging at a 10 C rate. FIG. 7 shows the capacity vs number of cycles for cycling at 20 C charge and 120 C discharge. Clearly the material is stable at 120 C discharge rate.

### Example 14

A membrane comprised of an interconnected network of polymer fibres was coated with nickel in a similar manner to previous examples. The thickness of the membrane was approximately 40 micrometres. The surface area of this membrane was estimated to be about 1.02 m²/cc. The weight of the nickel coating was approximately 0.0035 g/cm² or 0.88 g/cm³. The average thickness of the nickel coating was estimated as 96 nm.

The sample was activated by cycling via cyclic voltammetry for 1600 cycles at 20 mV/s and then charging and discharging at a 10 C rate. After activation, the discharge capacity of the sample stabilised at about 1.0 mAh/cm2 or 250 mAh/cc at 10 C charge/discharge rates. Then the sample was cycled at 30% depth of discharge (DOD) (i.e. average 0.3 mAh/cm2 or 75 mAh/cc discharge capacity) at about 10 C charge rate and 33 C discharge rate, and the charge and discharge rates were based on a capacity of 250 mAh/cc). FIG. 8 shows the capacity vs number of cycles for cycling at 30% DOD. Clearly the material is very stable at 30% DOD.

### Example 15

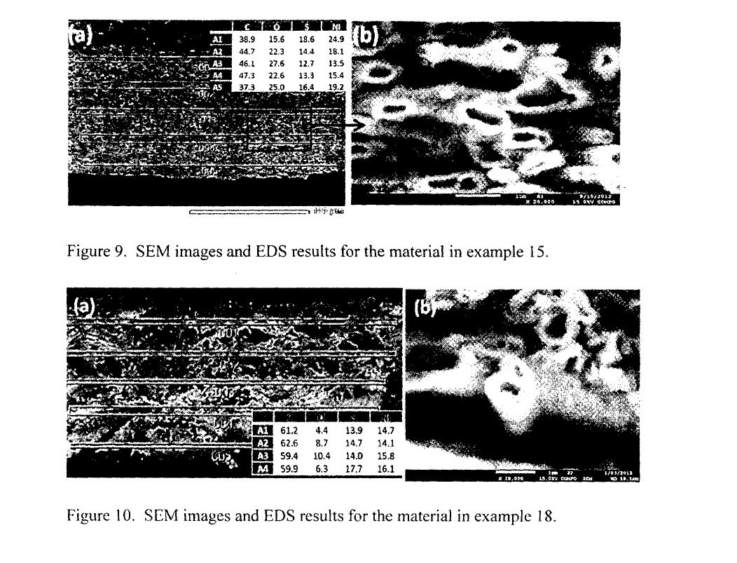

Nickel was coated onto a 0.45 um Cellulose Acetate (CA) membrane, ˜127 micrometres thick, using an electroless Ni coating approach similar to example 1. The coating of Nickel on a 125 um was timed to result in a ˜80 nm thick layer of nickel on the struts of the membrane, resulting in an electrical conductivity of 1-5 ohm cm. The struts of the conducting membranes were coated with elemental sulphur either through a controlled precipitation of sulphur from sulphur-containing compounds. The SEM microstructure of the membranes, FIG. 9, shows the struts of the membrane being uniformly coated with sulphur. The thickness of the coating varied from 100-300 nm. EDS analysis showed that the distribution of sulphur was reasonably consistent across the thickness of the membrane. The weight gain measurements of the membrane, before and after the sulphur coating, indicated a volume fraction of sulphur ˜28%, which corresponds to 56% of sulphur relative to the open pore space of the conductive membrane. The surface area of the material after sulphur coating, through BET surface area analysis, indicated to be 49.9 m2/g.

### Example 16

A sulphur sample was prepared in a similar manner to example 15, except a fibrous polymer membrane of 40 micrometre thickness was used. The volume, fraction of sulphur was estimated as ˜42%. This corresponds to about 84% of the open pore space in the membrane. The surface area was determined by BET analysis to be 41 m2/g after Sulphur coating. SEM microstructures are shown in FIG. 10. EDS analysis showed a reasonably consistent sulphur distribution across the membrane.

### Example 17

A sulphur sample was prepared in a similar manner to example 15, except a fibrous polymer membrane of 80 micrometre thickness was used. The volume fraction of sulphur was estimated as ˜17%. This corresponds to about 22% of the open pore space in the membrane. The surface area was determined by BET analysis to be ˜40 m2/g after sulphur coating.

### Example 18

A sulphur sample was prepared in a similar manner to example 17. NiS coating was formed by reacting the coated sulphur partially with underlying nickel layer by heating above the melting temperature of sulphur, about 140° C. in argon atmosphere for an hour. The thickness of the NiS coating varied from 100-300 nm. The weight gain measurements of the membrane, before and after the formation of NiS coating, indicated a volume fraction of ˜17% of NiS. This corresponds to a volume percentage of ˜23% of NiS relative to the open pore space of the membrane. The surface area of the material was determined by BET surface area analysis to be ˜41.6 m2/g after NiS formation.

### Example 19

A cellulose acetate membrane of nominal pore size 0.45 micrometres, thickness 127 micrometres and ˜66% porosity was coated with electroless nickel then electroless copper using methods similar to previous examples. Tin was then electrodeposited onto the metallic network. The volume fraction of tin was estimated to be ˜15%. The capacity of this sample was determined to be 10 mAh. This equates to a material utilisation of about 73% using a theoretical capacity for tin of 990 mAh/g.

### Example 20

A cellulose acetate membrane of nominal pore size 0.45 um was coated with nickel in a similar manner to previous examples. A surface area of ˜60 m2/g was measured. This is estimated to give a volumetric capacity of ˜70 m2/cc. Compared to the surface area of the polymer substrate (˜2.3 m2/cc) this shows that the volumetric surface area may be enhanced by metal coating. Thus it is possible to significantly increase the volumetric surface area, compared to the porous substrate, via metal coating, for example by a factor of ˜30.

1. An electrode material comprising a porous substrate coated with a coating comprising a conducting material and an active material, wherein the thickness of the coating is less than 1 micrometre and the volume fraction of active material is greater than 5%.

2-38. (canceled)

39. An electrode material as claimed in claim 1, wherein the electrode material comprises the porous substrate coated with the conductive material and active material and prior to coating the porous substrate has a specific surface area of greater than 0.1 m²/cm³, more preferably greater than 0.2 m²/cm³, more preferably greater than 1 m²/cm³, even more preferably greater than 4 m²/cm³, further preferably greater than 10 m²/cm³, even further preferably greater than 50 m²/cm³.

40. An electrode material as claimed in claim 1, wherein a calculated ratio of volume of active material to volume of the conducting material is greater than 1.5, or greater than 3, or greater than 4 or greater than 10.

41. An electrode material as claimed in claim 1, wherein a volume fraction of the conducting material is less than 20%, or less than 10%.

42. An electrode material as claimed in claim 1, wherein a surface area of the electrode material is greater than 0.1 m²/cm³, more preferably greater than 0.2 m²/cm³, more preferably greater than 1 m²/cm³, even more preferably greater than 4 m²/cm³, further preferably greater than 10 m²/cm³, even further preferably greater than 50 m²/cm³

43. An electrode material as claimed in claim 1, wherein the thickness of the conducting material is less than 500 nm thick, or less than 200 nm thick, or less than 100 nm thick, or less than 50 nm thick, or less than 20 nm thick.

44. An electrode material as claimed in claim 1, wherein the thickness of the conducting material and the active material taken together in the coating, is less than 500 nm thick, or less than 200 nm thick, or less than 100 nm thick, or less than 50 nm thick, or less than 20 nm thick.

45. An electrode material comprising:
(i) a metallic network structure comprising a metallic material,
(ii) an active material connected to the metallic structure,
wherein the calculated volume fraction of active material is greater than 5%, and the specific surface area of the metallic network structure is greater than 0.1 m²/cm³ and wherein the specific surface area of the active material connected to the metallic structure is greater than 0.1 m²/cm³.

46. The electrode material of claim 45, wherein the calculated volume fraction of the active material is greater than 30%, and the surface area of the active material is greater than 20 m²/g material.

47. The electrode material of claim 1, wherein the total thickness of the electrode material is greater than 1 μm, or greater than 10 μm, or greater than 80 μm, or greater than 200 μm, or greater than 400 μm.

48. The electrode material of claim 44, wherein the calculated ratio of volume of active material to volume of metallic material is greater than 1.5, preferably greater than 3, or greater than 4 or even more preferably greater than 10 and the volume fraction of the metallic material is less than 20%, preferably less than 10%.

49. An electrode material comprising a nickel-containing compound wherein the ratio of the gravimetric capacity at 10 C to the maximum achievable gravimetric capacity at 2 C is greater than 70%, and the electrode material can maintain greater than 75% of its capacity at a given rate of discharge after cycling for more than 1000 cycles at this given rate of discharge.

50. An electrode material as claimed in claim 49, wherein the ratio of the gravimetric capacity at 60 C to the maximum achievable gravimetric capacity at 2 C is greater than 60%, and the electrode material can maintain greater than 75% of its capacity at a given rate of discharge after cycling for more than 1000 cycles at this given rate of discharge.

51. An electrode material as claimed in claim 49, wherein the ratio of the gravimetric capacity at 120 C to the maximum achievable gravimetric capacity at 2 C is greater than 50%, and the electrode material can maintain greater than 75% of its capacity at a given rate of discharge after cycling for more than 1000 cycles at this given rate of discharge.

52. An electrode material as claimed in claim 49, wherein the electrode material can maintain greater than 75% of its capacity at a given rate of discharge after cycling for more than 2000 cycles, or more than 5000 cycles at this given rate of discharge.

53. An electrode as claimed in claim 49, wherein the electrode maintains at least 80% of its capacity at the specified discharge rate, after charge/discharge cycling for greater than 1000 cycles at the specified discharge rate or wherein the electrode material maintains at least 80% of its capacity at the specified discharge rate, after charge/discharge cycling for greater than 5000 cycles at the specified discharge rate or wherein the electrode maintains at least 80% of its capacity at the specified discharge rate, after charge/discharge cycling for greater than 10,000 cycles at the specified discharge rate.

54. An electrode as claimed in claim 1, wherein the specific power of the electrode, calculated from the total weight of the electrode, is greater than 2 W/g or 5 W/g or 10 W/g or 20 W/g.
